(19) United States
(12) Patent Application Publication
(10) Pub. No.: US 2026/0067823 A1
(43) Pub. Date: Mar. 5, 2026

(54) RX MODE SWITCH AND FALLBACK OPERATION FOR LOW-POWER WAKEUP RECEIVER

(71) Applicant: QUALCOMM Incorporated, San Diego, CA (US)

(72) Inventors: Chao WEI, Beijing (CN); Wanshi Chen, San Diego, CA (US); Peter GAAL, San Diego, CA (US); Huilin XU, Temecula, CA (US); Ahmed ELSHAFIE, San Diego, CA (US); Yuchul KIM, San Diego, CA (US); Wei YANG, San Diego, CA (US); Linhai HE, San Diego, CA (US)

(21) Appl. No.: 19/103,520

(22) PCT Filed: Sep. 23, 2022
(86) PCT No.: PCT/CN2022/120769

§ 371 Date: Feb. 12, 2025

(51) Int. Cl. H04W 52/02; H04W 88/06

(52) U.S. Cl. CPC H04W 52/0245; H04W 52/0216; H04W 52/0235; H04W 88/06

(57) ABSTRACT

A UE may measure a signal strength or signal quality of a serving cell. The UE may select whether to use an LP-WUR, a main radio, or both the LP-WUR and the main radio for signal monitoring based on the measured signal strength or signal quality of the serving cell. The signal monitoring may be associated with at least one of WUS monitoring, SSB monitoring, or RRM measurement. The signal strength or the signal quality of the serving cell may be measured using the main radio. The UE may receive an indication of at least one threshold from a network node. Whether to use the LP-WUR, the main radio, or both the LP-WUR and the main radio for the signal monitoring may be selected based further on the at least one threshold.

### TECHNICAL FIELD

The present disclosure relates generally to communication systems, and more particularly, to signal monitoring using one or more of a wakeup receiver (WUR) and a main radio in a wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may measure a signal strength or signal quality of a serving cell. The apparatus may select whether to use a low power-wakeup receiver (LP-WUR), a main radio, or both the LP-WUR and the main radio for signal monitoring based on the measured signal strength or signal quality of the serving cell. The signal monitoring may be associated with at least one of wakeup signal (WUS) monitoring, synchronization signal block (SSB) monitoring, or radio resource management (RRM) measurement.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a block diagram illustrating example operations of a WUR at a UE according to one or more aspects.

FIG. 5 is a diagram illustrating an example process of paging monitoring using the WUS according to one or more aspects.

FIG. 6 is a block diagram illustrating an example architecture of a WUR using a single bit analog-to-digital (ADC) converter or a comparator according to one or more aspects.

FIG. 7 is an example diagram illustrating the selection of the receiver for the signal monitoring based on received signal power/quality thresholds according to one or more aspects.

FIG. 8 is an example diagram illustrating the selection of the receiver for the signal monitoring based on serving cell signal level thresholds for cell reselection according to one or more aspects.

FIG. 9 is a diagram illustrating example multiplexing schemes in scenarios where both the main radio and the WUR are used for the signal monitoring according to one or more aspects.

FIG. 10 is a diagram of a communication flow of a method of wireless communication according to one or more aspects.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

### DETAILED DESCRIPTION

A wake-up receiver (WUR) (also referred to as a wake-up radio) (e.g., an LP-WUR) may be a simple companion radio receiver circuit designed to have a lower energy consumption. An example of an LP-WUR may include a non-coherent envelope detector. In general, a WUR may not provide a communication range and/or a communication quality comparable to the main radio. For example, the main radio may have better receiver sensitivity and interference rejection performance than the WUR. If activation of the main radio (receiver) is based on whether the WUS is detected (e.g., the main radio is activated if the WUS is detected and is not activated if the WUS is not detected), there may be a risk that the UE may not be able to correctly wake up the main radio when the UE moves out of the coverage area of the WUS. For example, a network node may send a WUS; however, if the UE is at the cell edge, the WUR at the UE may not be able to detect the WUS.

According to one or more aspects, a UE may measure a signal strength or signal quality of a serving cell. The UE may select whether to use an LP-WUR, a main radio, or both the LP-WUR and the main radio for signal monitoring based on the measured signal strength or signal quality of the serving cell. The signal monitoring may be associated with at least one of WUS monitoring, SSB monitoring, or RRM measurement. Accordingly, by using the appropriate receiver for signal monitoring, the UE may not miss any WUS and may not fail to wake up the main radio when the UE is at the cell edge. Further, power savings associated with the use of the WUR may be preserved by not waking up the main radio unnecessarily frequently. The aspects may be used even if the WUR uses a single-bit analog-to-digital converter (ADC) or comparator.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

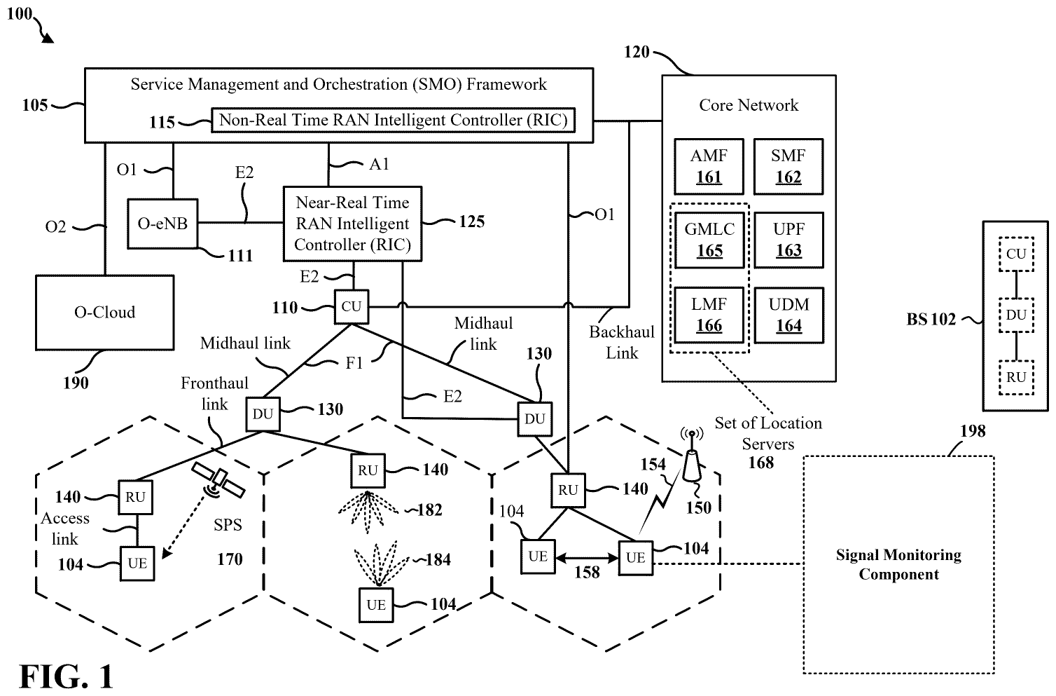

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHZ) and FR2 (24.25 GHz-52.6 GHZ). Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a signal monitoring component 198 that may be configured to measure a signal strength or signal quality of a serving cell. The signal monitoring component 198 may be configured to select whether to use an LP-WUR, a main radio, or both the LP-WUR and the main radio for signal monitoring based on the measured signal strength or signal quality of the serving cell. The signal monitoring may be associated with at least one of WUS monitoring, SSB monitoring, or RRM measurement. Although the following description may be focused on 5G NR, the concepts described herein may be applicable to other similar areas, such as LTE, LTE-A, CDMA, GSM, and other wireless technologies.

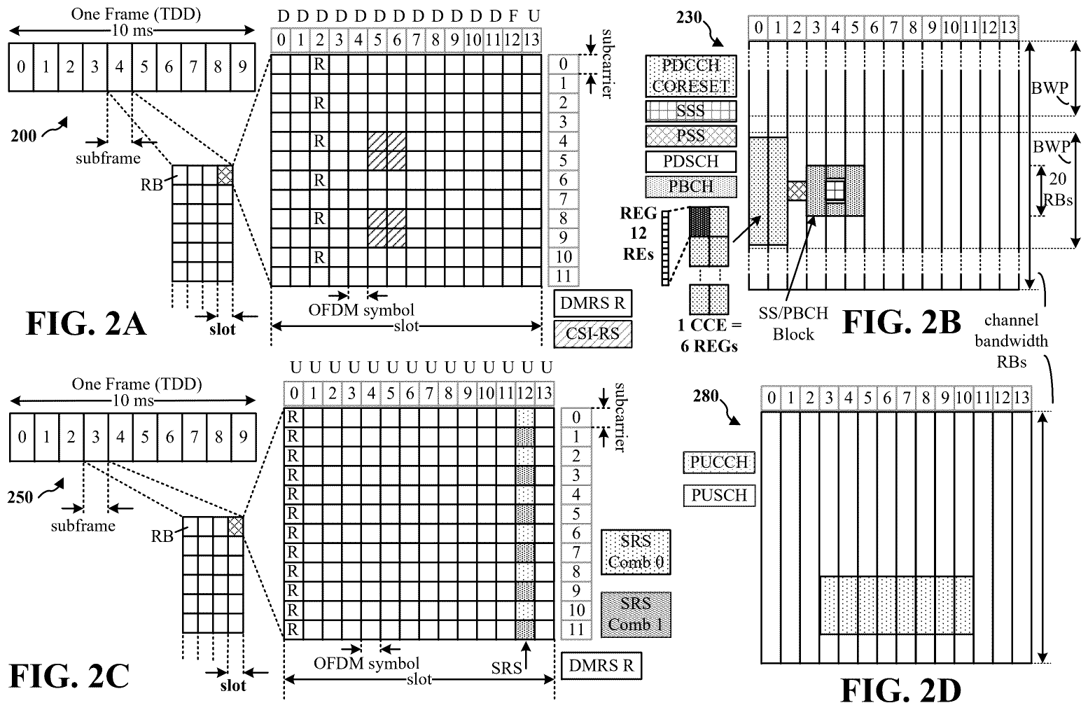

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

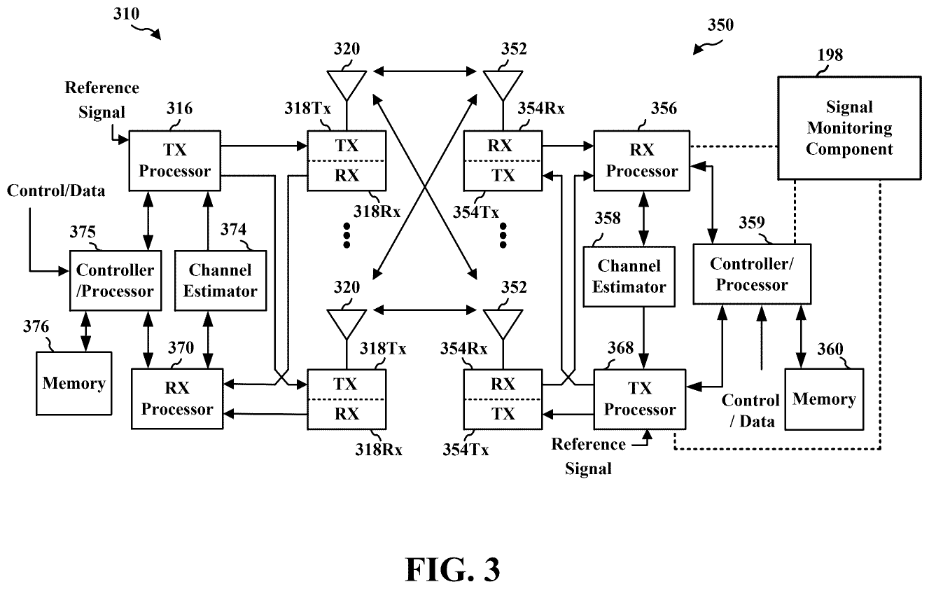

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the signal monitoring component 198 of FIG. 1.

A WUR (also referred to as a wake-up radio) (e.g., an LP-WUR) may be a simple companion radio receiver circuit designed to have a lower energy consumption. An example of an LP-WUR may include a non-coherent envelope detector.

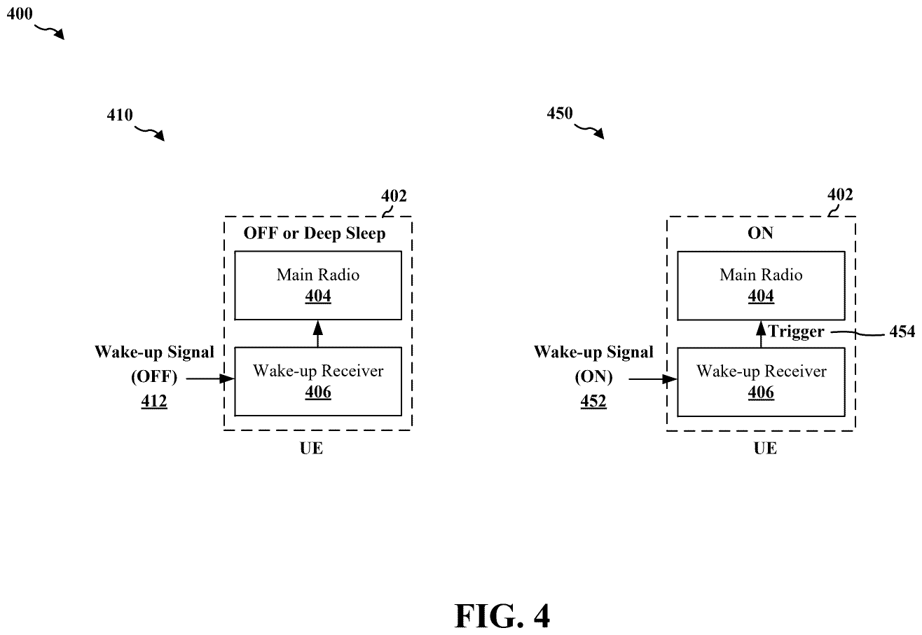

FIG. 4 is a block diagram 400 illustrating example operations of a WUR at a UE according to one or more aspects. As shown, the UE 402 may include a main radio 404 and a WUR 406. The diagram 410 illustrates an example scenario where the UE 402 may have no data to receive. In the diagram 410, the main radio 404 may be switched off (or placed in a deep sleep state), unless the UE 402 has data to transmit. When the main radio 404 is off (or in the deep sleep state), the WUR 406 (e.g., an LP-WUR 406) may be active, and may be used to monitor for WUSs 412 (e.g., low power WUSs 412).

The diagram 450 illustrates an example scenario where the UE 402 has data to receive. In the diagram 450, the WUR 406 may receive a WUS 452 (e.g., an on-demand low power WUS 452). Based on the WUS 452, the WUR 406 may transmit a trigger signal 454 to the main radio 404 to activate the main radio 404. After the main radio 404 is activated, the UE 402 may transmit and/or receive data using the main radio 404.

The WUR may be associated with a lower energy consumption than some duty cycling-based schemes. Therefore, a WUR may not suffer from the tradeoff between latency and efficiency (e.g., unlike some duty cycling-based schemes). In particular, because the power consumption at the WUR (e.g., the LP-WUR) may be low, WUS monitoring at the WUR may be performed frequently in order to satisfy a latency specification. Further, with the use of the WUR, unnecessarily waking up the main radio for PDCCH monitoring may be avoided (unnecessarily waking up the main radio may be costly in terms of power consumption). Accordingly, deployment of the WUR and the WUS may be suitable for IoT use cases or idle/inactive mode UEs (e.g., UEs in the RRC Idle or the RRC Inactive mode).

In addition to monitoring for the WUS (e.g., the low power WUS), which may be targeted to paging reception, the WUR may also be used to monitor a low power RS (LP-RS) for time/frequency tracking (e.g., for maintaining synchronization with the network) and/or RRM. With the use of the LP-RS, serving cell monitoring may be offloaded from the main radio to the WUR, and the frequency of main radio wake up may be reduced. As a result, power saving may be achieved.

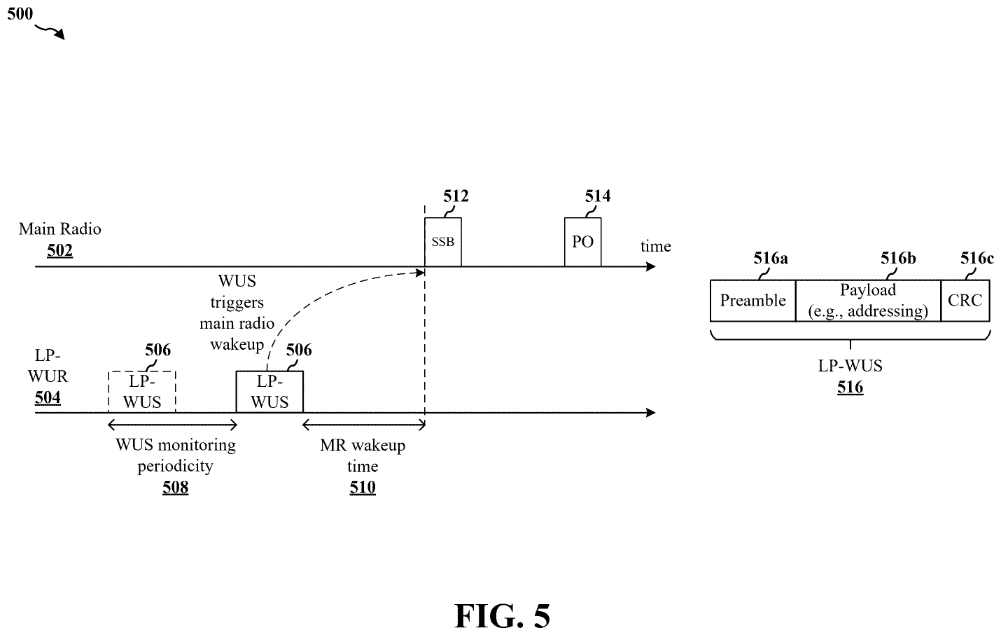

FIG. 5 is a diagram 500 illustrating an example process of paging monitoring using the WUS according to one or more aspects. In some configurations, the use of the WUS (e.g., the LP-WUS) may help to reduce the number of (unnecessary) paging receptions at the UE. The network may transmit an LP-WUS 516 at an LP-WUS occasion 506 if there is paging for a UE in an idle mode (e.g., an RRC Idle mode) or an inactive mode (e.g., an RRC Inactive mode). A time period between two adjacent LP-WUS occasions 506 may correspond to a WUS monitoring period 508. When the UE detects an LP-WUS 516 via the LP-WUR 504, the UE may turn on the main radio 502. After the passage of the main radio wakeup time 510, the main radio 502 may monitor for the SSB 512. The main radio 502 may achieve synchronization with the network based on the SSB 512. Then, the UE may receive the paging message at the paging occasion (PO) 514. On the other hand, if the UE does not detect any LP-WUS, the UE may leave the main radio 502 in an off state or a deep sleep state (mode) in order to save power.

In one or more configurations, the LP-WUS 516 may be a message-based WUS. In particular, the LP-WUS 516 may include a preamble 516a, a payload 516b, and a check code such as a cyclic redundancy check (CRC) 516c. In particular, the payload 516b may include addressing information. In some configurations, the payload 516b may include more than 1 bit. For example, the payload 516b may include a cell identifier (ID) for cell identification and/or UE addressing (e.g., a UE ID) for paging (early) indication.

In one or more configurations, the LP-WUS 516 may be a sequence-based WUS (not shown). In particular, the sequence-based LP-WUS may include a predefined set of sequences associated with the cell ID or a UE ID.

In general, a WUR may not provide a communication range and/or a communication quality comparable to the main radio. For example, the main radio may have better receiver sensitivity and interference rejection performance than the WUR. If activation of the main radio (receiver) is based on whether the WUS is detected (e.g., the main radio is activated if the WUS is detected and is not activated if the WUS is not detected), there may be a risk that the UE may not be able to correctly wake up the main radio when the UE moves out of the coverage area of the WUS. For example, a network node may send a WUS; however, if the UE is at the cell edge, the WUR at the UE may not be able to detect the WUS.

To make sure the main radio is waken up even if the UE is at the cell edge, in one configuration, the UE may periodically wake up the main radio even if no WUS is detected in order to ensure the proper connection to the network node. This approach may lead to increased power consumption because the main radio may be waken up frequently. In another configuration, the UE may evaluate the link quality of the WUR, and may select whether to switch to the main radio for paging monitoring and/or RRM measurement based on a measurement of a low power-synchronization signal (LP-SS) (the LP-SS may be based on on-off keying). This approach may be used if the WUR is able to perform RRM measurements. However, depending on the implementation of the WUR, the WUR may or may not be able to perform RRM measurements.

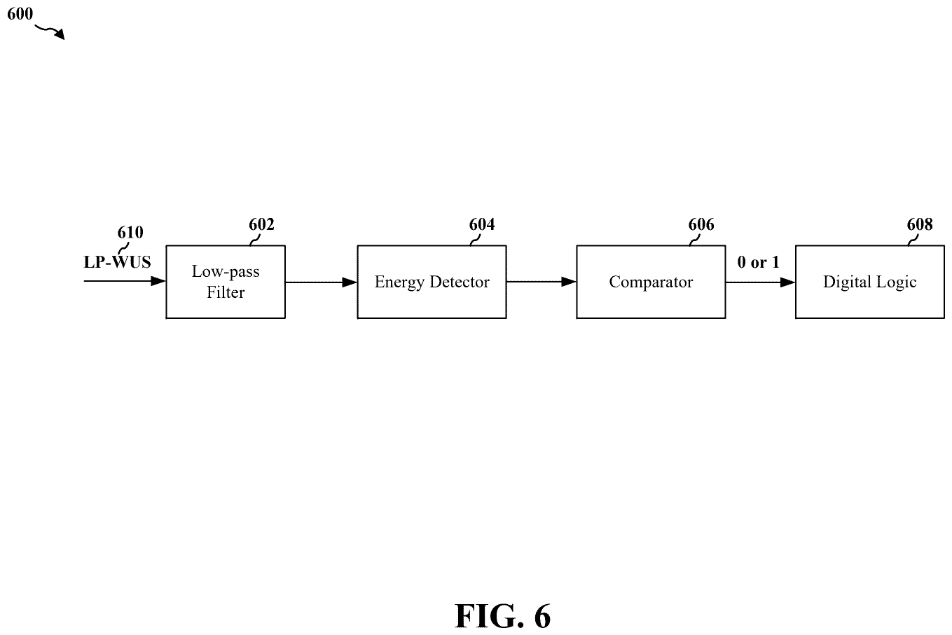

FIG. 6 is a block diagram 600 illustrating an example architecture of a WUR using a single bit ADC converter or a comparator according to one or more aspects. As shown, the WUR may include a low-pass filter 602, an energy detector 604, a comparator 606, and digital logic 608. An inputted WUS 610 (e.g., an LP-WUS 610) may be low-pass filtered at the low-pass filter 602. Then the energy detector 604 may detect the energy of the WUS 610. The output from the energy detector 604 may be compared to a reference energy level at the comparator 606 (or a single-bit ADC). Based on the comparison, the result outputted by the comparator 606 may be a 0 or a 1. The digital logic 608 may generate the output of the WUR based on the result outputted by the comparator 606. A WUR using a comparator or a single bit ADC may consume less power than a WUR that uses a multi-bit ADC; however, a WUR using a comparator or a single bit ADC may not be able to measure the signal power in the digital baseband.

In one configuration, a network node (e.g., a base station) may configure two power thresholds for the UE to determine whether the WUR of the UE is to be activated and used to monitor for the WUS for paging indication and/or to perform RRM measurements. The UE may measure the received power of the network node (e.g., the received power of the serving cell), and may compare the measured received power to the power thresholds. Based on the comparison, the UE may select either to switch on the WUR and use the WUR, alone or jointly with the main radio, to perform signal monitoring, or not to switch on the WUR and instead use the main radio alone to perform the signal monitoring.

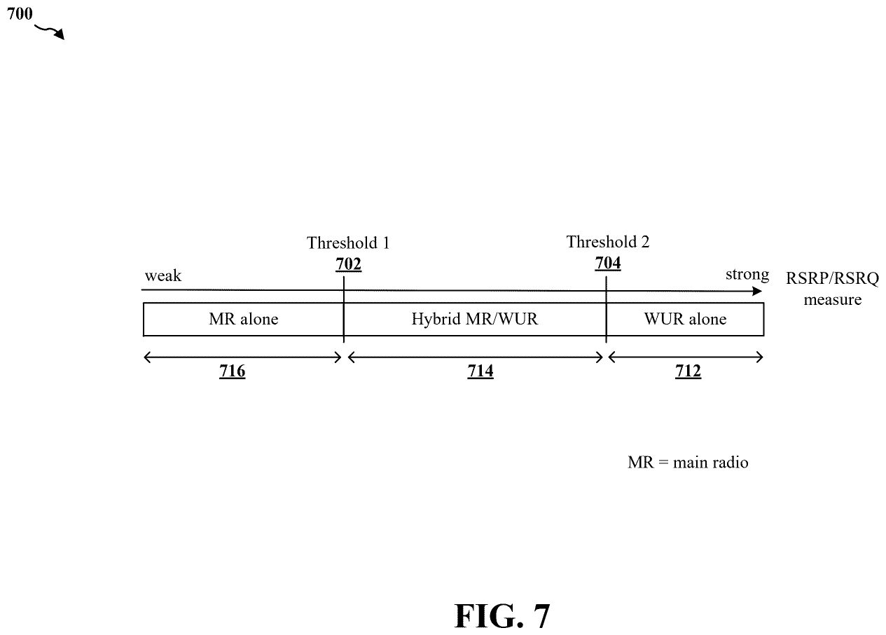

FIG. 7 is an example diagram 700 illustrating the selection of the receiver for signal monitoring based on received signal power/quality thresholds according to one or more aspects. The signal monitoring may correspond to (include) paging monitoring and/or RRM measurement. As shown, the network node may configure a first threshold 702 and a second threshold 704, where the second threshold 704 may correspond to a stronger signal power/quality than the first threshold 702. The UE may measure a signal power/quality of the network node (serving cell) (e.g., a reference signal received power (RSRP) measurement or a reference signal received quality (RSRQ) measurement). If the measured signal power/quality is greater than the second threshold 704 (i.e., falls within a first range 712), the UE may activate the WUR and may use the WUR alone to perform the signal monitoring. If the measured signal power/quality is less than the second threshold 704 but greater than the first threshold 702 (i.e., falls within a second range 714), the UE may activate the WUR and may use both the main radio and the WUR jointly to perform the signal monitoring (i.e., hybrid main radio/WUR monitoring). Further, if the measured signal power/quality is less than the first threshold 702 (i.e., falls within a third range 716), the UE may not activate the WUR, and may use the main radio alone for the signal monitoring.

In one or more configurations, the DL RS used for received signal power/quality measurement at the UE (e.g., for selecting the receiver(s) for the signal monitoring) may be at least one of an SSB, a CSI-RS, or an LP-SS. In particular, the SSB or the CSI-RS may be used if the SSB or the CSI-RS is quasi co-located (QCLed) with the WUS (e.g., using a same TX beam from the same TX node). If no RS QCLed with the WUS is available (e.g., the SSB and the WUS may use different TX beams), the LP-SS may be used for the received signal power/quality measurement at the UE.

In one configuration, the UE may report the selected receiver for paging monitoring and/or RRM measurement to the network node to assist the network node in the configuration of the WUS transmission. Further, if the hybrid main radio/WUR signal monitoring is used, the UE may report the signal power/quality measurement results to the network node to assist the network node in the configuration of a periodic main radio wakeup pattern at the UE. For example, the better the radio link quality (the higher the received signal power/quality), the less frequent the main radio may be waken up.

In one configuration, for a UE in an RRC inactive state, the UE may provide the signal power/quality measurement results to the network node using the small data transmission (SDT) procedure without transitioning into the RRC connected state (mode).

In one or more configurations, the cell selection signal received level (Srxlev) (as described in technical specification (TS) 38.304) thresholds (e.g., in dB) (e.g., the threshold S_{IntraSearchP} for intra-frequency measurement and the threshold S_{nonIntraSearchP} for inter-frequency and inter-RAT measurements) for cell reselection may be reused as the signal power thresholds for receiver selection for signal monitoring.

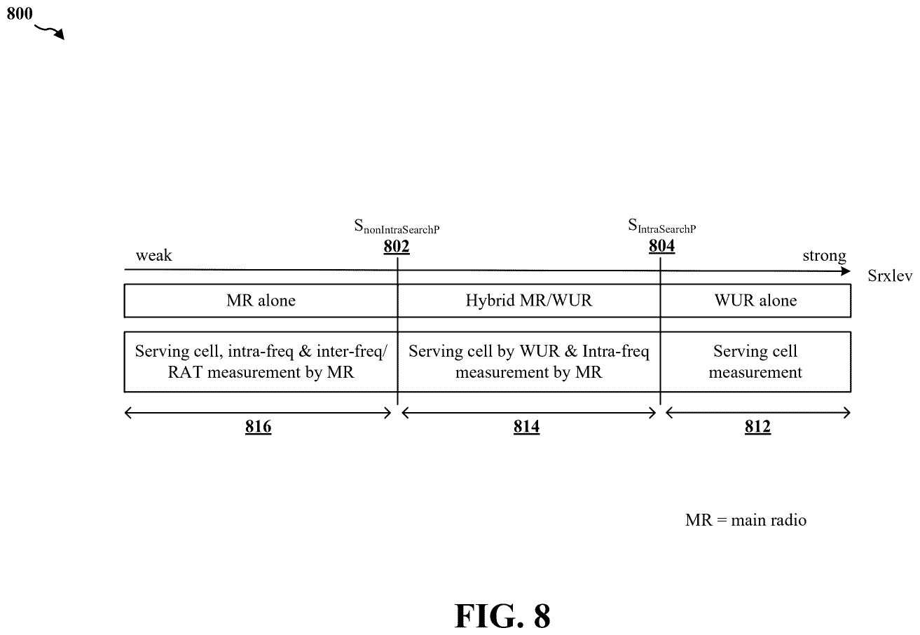

FIG. 8 is an example diagram 800 illustrating the selection of the receiver for signal monitoring based on serving cell signal level thresholds for cell reselection according to one or more aspects. As shown, the threshold S_{nonIntraSearchP} 802 may correspond to the first threshold 702 in FIG. 7 and the threshold S_{IntraSearchP} 804 may correspond to the second threshold 704 in FIG. 7.

If the measured signal power level is greater than the threshold S_{IntraSearchP} 804 (i.e., falls within a first range 812), the UE may activate the WUR and may use the WUR alone to perform the signal monitoring. In particular, the UE may perform the signal monitoring in the serving cell using the WUR and not for other cells.

If the measured signal power level is less than the threshold S_{IntraSearchP} 804 but greater than the threshold S_{nonIntraSearchP} 802 (i.e., falls within a second range 814), the UE may activate the WUR and may use both the main radio and the WUR jointly to perform the signal monitoring (i.e., hybrid main radio/WUR monitoring). In particular, the UE may perform the signal monitoring in the serving cell using the WUR, and may perform the intra-frequency neighboring cell measurements (e.g., RRM measurements) using the main radio.

Further, if the measured signal power level is less than the threshold S_{nonIntraSearchP} 802 (i.e., falls within a third range 816), the UE may not activate the WUR, and may use the main radio alone for the signal monitoring. In particular, the UE may perform the signal monitoring in the serving cell as well as the intra-frequency, inter-frequency, and/or inter-RAT neighboring cell measurements using the main radio alone.

In different configurations, the WUR may be used for serving cell measurements but not for neighboring cell RRM measurements (the UE may perform neighboring cell RRM measurements using the main radio) because the WUR may be a low complexity receiver, and may have reduced (degraded) performance if there is more than one LP-SS sequence to detect. For example, the WUR may detect whether its “own” signal is transmitted, but may not detect exactly what sequence is transmitted if its “own” signal is not transmitted.

In one or more configurations, if the UE reports its WUR capability for neighboring cell RRM measurements to the network node, the network node may select whether to use the same cell reselection signal power level thresholds for receiver selection (WUR activation determination) for the signal monitoring.

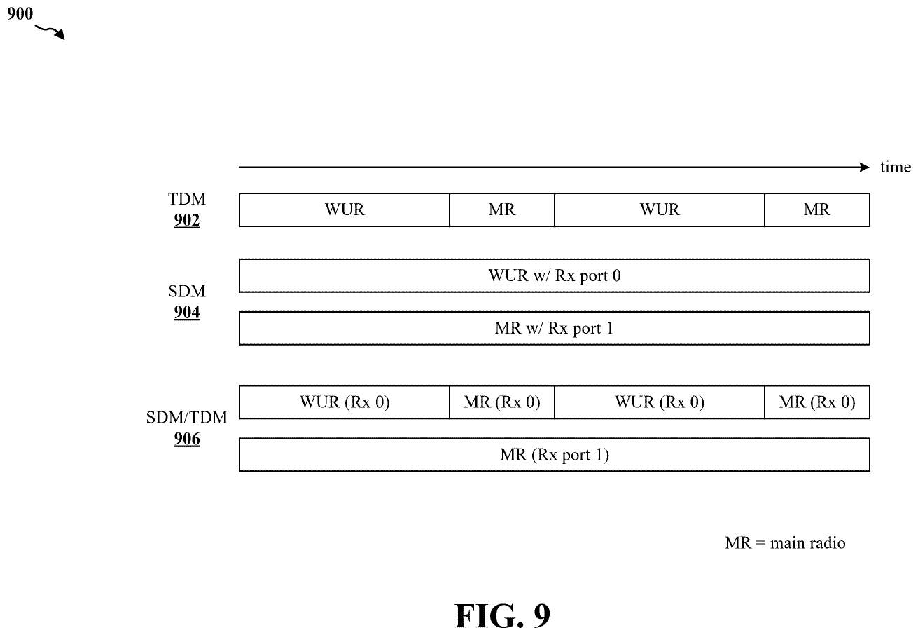

FIG. 9 is a diagram 900 illustrating example multiplexing schemes in scenarios where both the main radio and the WUR are used for the signal monitoring according to one or more aspects. For hybrid main radio/WUR signal monitoring, the main radio and the WUR may be time division multiplexed (TDMed), spatial division multiplexed (SDMed), or multiplexed with a combination 906 of time division multiplexing (TDM) and spatial division multiplexing (SDM).

For TDM 902, the network node may configure a time switching pattern for periodic switching between the WUR and the main radio. For example, based on the time switching pattern, for every N paging cycles, the WUR may be active in the first N1 cycles, and the main radio may be active in the remaining cycles for paging monitoring and RRM measurements. The value of NI may be configured based on the UE measurement report.

Further, for SDM 904, for a UE with multiple RX antennas (antenna ports), the WUR may utilize one RX antenna (port), while the other RX antennas (antenna ports) may be used by the main radio. Moreover, antenna (port) switching between the WUR and the main radio may be executed based on the WUS being detected by the WUR.

In one configuration, the network node may provide to the UE with a set of criteria associated with the UE triggering a fallback to the main radio while the WUR is activated. This configuration may be used when the UE is at the cell edge. The criteria associated with the fallback may be based on the UE capability (e.g., whether the WUR includes a single-bit ADC or a multi-bit ADC). Further, the criteria may be based on one or more of a timer that is started or restarted after the UE receives a valid LP-SS or WUS via the WUR (e.g., a fallback may be executed when the timer expires), a number of LP-SSs that missed detection by the WUR within a time interval (e.g., a fallback may be executed when a threshold number of LP-SSs have missed detection), or the RSRP of the LP-SS being below a threshold (e.g., a fallback may be executed when the RSRP of the LP-SS is below the threshold). Accordingly, based on the criteria associated with the fallback, the UE may wake up the main radio when the signal/channel quality is poor and may not wake up the main radio when the signal/channel quality is satisfactory. Compared to periodically waking up the main radio, the criteria-based fallback approach may be associated with less power consumption.

The RSRP measurement criterion described above may be supported if the WUR has a multi-bit ADC because in order to evaluate whether the criterion is met, the WUR may need to be able to measure the LP-SS signal power in the baseband.

In some further configurations, a fallback to the main radio may be triggered for any of a number of possible reasons. The reasons may include, for example, that the signal power of the LP-SS/WUS is too weak to detect, that the WUR loses synchronization, or that the LP-SS transmission is dropped due to collision, and so on.

In one or more configurations, when the fallback to the main radio occurs, the UE may report a failure of the WUR to the network node. The reporting may be based on a random access channel (RACH) procedure or an SDT procedure using a (pre)configured dedicated resource.

In one or more configurations, the failure of the WUR may not trigger any cell reselection if the UE is in the RRC idle/inactive state (mode), and may not trigger a radio link failure if the UE is in the RRC connected state (mode). It may be up to network node implementation to ensure, via suitable and proper parameter configurations, that the failure of the WUR occurs before the main radio failure, so that the UE may not wake up the main radio frequently to detect whether there is any radio link quality problem for the main radio when the WUR is active.

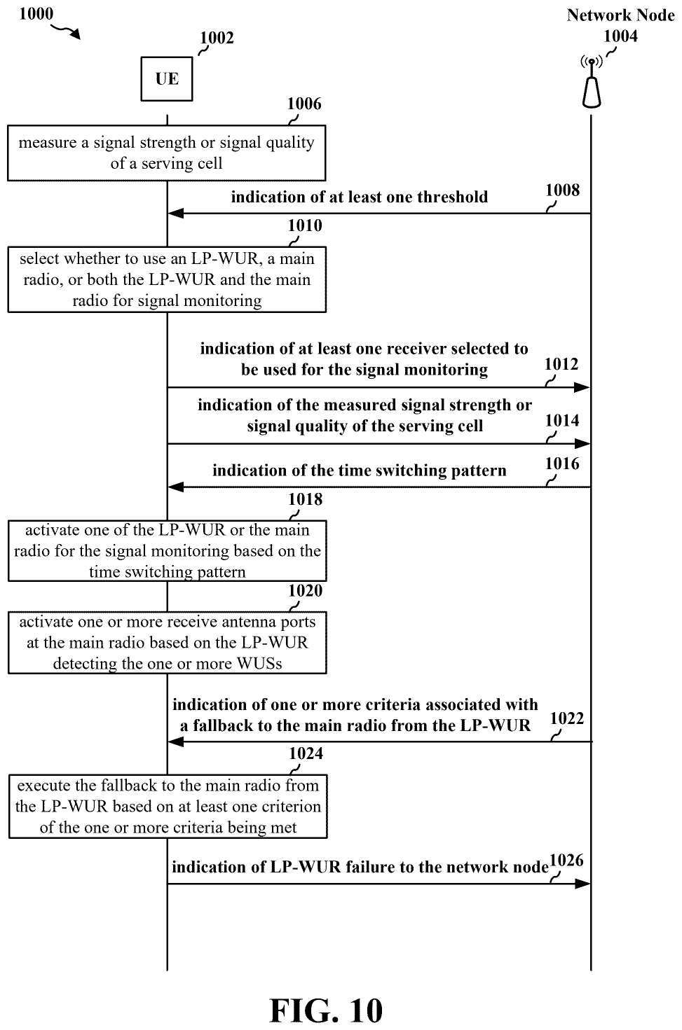

FIG. 10 is a diagram of a communication flow 1000 of a method of wireless communication according to one or more aspects. The UE 1002 may implement aspects of the UE 402 in FIG. 4. At 1006, the UE 1002 may measure a signal strength or signal quality of a serving cell.

In one configuration, the signal strength or the signal quality of the serving cell may be measured using the main radio.

In one configuration, the signal strength or signal quality of the serving cell may be measured based on at least one of an SSB, a CSI-RS, or an LP-SS. The LP-SS may be based on on-off keying.

In one configuration, the signal strength or signal quality of the serving cell may be measured based on the SSB or the CSI-RS. The SSB or the CSI-RS may be QCLed with an LP-WUS associated with the WUS monitoring.

At 1008, the UE 1002 may receive an indication of at least one threshold from a network node 1004.

At 1010, the UE 1002 may select whether to use an LP-WUR, a main radio, or both the LP-WUR and the main radio for signal monitoring based on the measured signal strength or signal quality of the serving cell. The signal monitoring may be associated with at least one of WUS monitoring, SSB monitoring, or RRM measurement.

In one configuration, whether to use the LP-WUR, the main radio, or both the LP-WUR and the main radio for the signal monitoring may be selected based further on the at least one threshold as indicated at 1008.

In one configuration, the at least one threshold may include a first threshold and a second threshold. The LP-WUR alone may be selected to be used for the signal monitoring if the measured signal strength or signal quality of the serving cell is greater than the first threshold. Both the LP-WUR and the main radio may be selected to be used for the signal monitoring if the measured signal strength or signal quality of the serving cell is less than the first threshold but greater than the second threshold. The main radio alone may be selected to be used for the signal monitoring if the measured signal strength or signal quality of the serving cell is less than the second threshold.

In one configuration, the first threshold may be associated with intra-frequency measurement for cell reselection. The second threshold may be associated with inter-frequency or inter-RAT measurement for cell reselection.

In one configuration, the measured signal strength or signal quality of the serving cell may be greater than the first threshold. The LP-WUR alone may be selected to be used for the signal monitoring. The signal monitoring may correspond to the WUS monitoring or the RRM measurement. The RRM measurement may be associated with the serving cell.

In one configuration, the measured signal strength or signal quality of the serving cell may be less than the first threshold but greater than the second threshold. Both the LP-WUR and the main radio may be selected to be used for the signal monitoring. The signal monitoring may correspond to at least one of the WUS monitoring using the LP-WUR, the RRM measurement associated with the serving cell using the LP-WUR, or the RRM measurement associated with a non-serving (e.g., neighboring) cell using the main radio.

In one configuration, the measured signal strength or signal quality of the serving cell may be less than the second threshold. The main radio alone may be selected to be used for the signal monitoring. The signal monitoring may correspond to the SSB monitoring or the RRM measurement associated with the serving cell or a non-serving (e.g., neighboring) cell.

At 1012, the UE 1002 may transmit an indication of the at least one receiver selected to be used for the signal monitoring to a network node 1004. The at least one receiver may correspond to the LP-WUR alone, the main radio alone, or both the LP-WUR and the main radio.

At 1014, the UE 1002 may transmit an indication of the measured signal strength or signal quality of the serving cell to the network node 1004. A main radio wakeup pattern may be based on the measured signal strength or signal quality of the serving cell.

In one configuration, the UE 1002 may be in an RRC inactive state. The indication of the measured signal strength or signal quality of the serving cell may be transmitted to the network node 1004 via an SDT.

In one configuration, both the LP-WUR and the main radio may be selected to be used for the signal monitoring. The signal monitoring may correspond to at least the WUS monitoring using the LP-WUR and the SSB monitoring using the main radio. The WUS monitoring using the LP-WUR and the SSB monitoring using the main radio may be TDMed and/or SDMed.

In one configuration, the WUS monitoring using the LP-WUR and the SSB monitoring using the main radio may be TDMed based on a time switching pattern. At 1016, the UE 1002 may receive an indication of the time switching pattern from a network node 1004.

In one configuration, the time switching pattern may include a proportion (or a first number) of paging cycles (e.g., NI paging cycles as described above) associated with the WUS monitoring using the LP-WUR in a predefined number of paging cycles (e.g., N paging cycles as described above). The proportion (first number) of paging cycles may be based on the measured signal strength or signal quality of the serving cell

At 1018, the UE 1002 may activate one of the LP-WUR or the main radio for the signal monitoring based on the time switching pattern.

In one configuration, the WUS monitoring using the LP-WUR and the SSB monitoring using the main radio may be SDMed. The LP-WUR and the main radio may be associated with different receive antenna ports. At 1020, the UE 1002 may activate one or more receive antenna ports at the main radio based on the LP-WUR detecting one or more WUSs.

At 1022, the UE 1002 may receive an indication of one or more criteria associated with a fallback to the main radio from the LP-WUR from a network node 1004. The one or more criteria may be associated with at least one of a timer that is started or restarted after an LP-SS or an LP-WUS is received, a predefined number of missed LP-SSs within a time interval, or a signal strength threshold associated with the LP-SSs.

At 1024, the UE 1002 may execute the fallback to the main radio from the LP-WUR based on at least one criterion of the one or more criteria being met.

At 1026, the UE 1002 may transmit an indication of LP-WUR failure to the network node 1004 based on the fallback to the main radio from the LP-WUR.

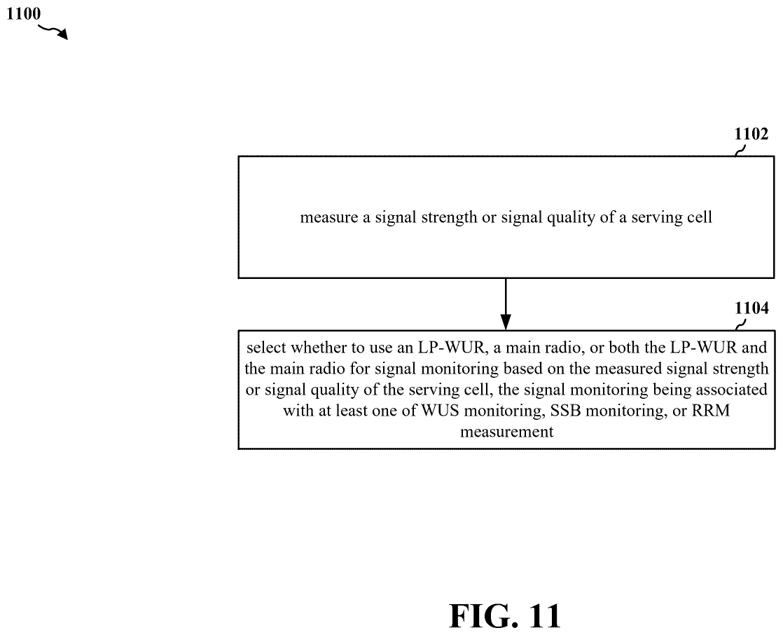

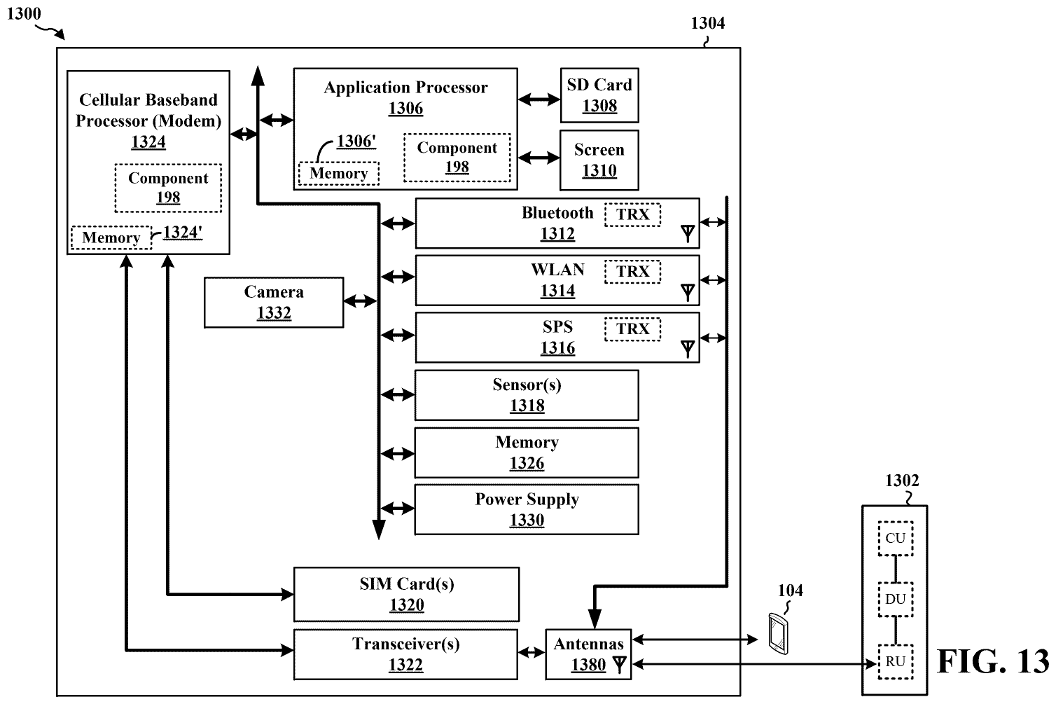

FIG. 11 is a flowchart 1100 of a method of wireless communication. The method may be performed by a UE (e.g., the UE 104/350/1002; the apparatus 1304). At 1102, the UE may measure a signal strength or signal quality of a serving cell. For example, 1102 may be performed by the component 198 in FIG. 13. Referring to FIG. 10, at 1006, the UE 1002 may measure a signal strength or signal quality of a serving cell.

At 1104, the UE may select whether to use an LP-WUR, a main radio, or both the LP-WUR and the main radio for signal monitoring based on the measured signal strength or signal quality of the serving cell. The signal monitoring may be associated with at least one of WUS monitoring, SSB monitoring, or RRM measurement. For example, 1104 may be performed by the component 198 in FIG. 13. Referring to FIG. 10, at 1010, the UE 1002 may select whether to use an LP-WUR, a main radio, or both the LP-WUR and the main radio for signal monitoring based on the measured signal strength or signal quality of the serving cell.

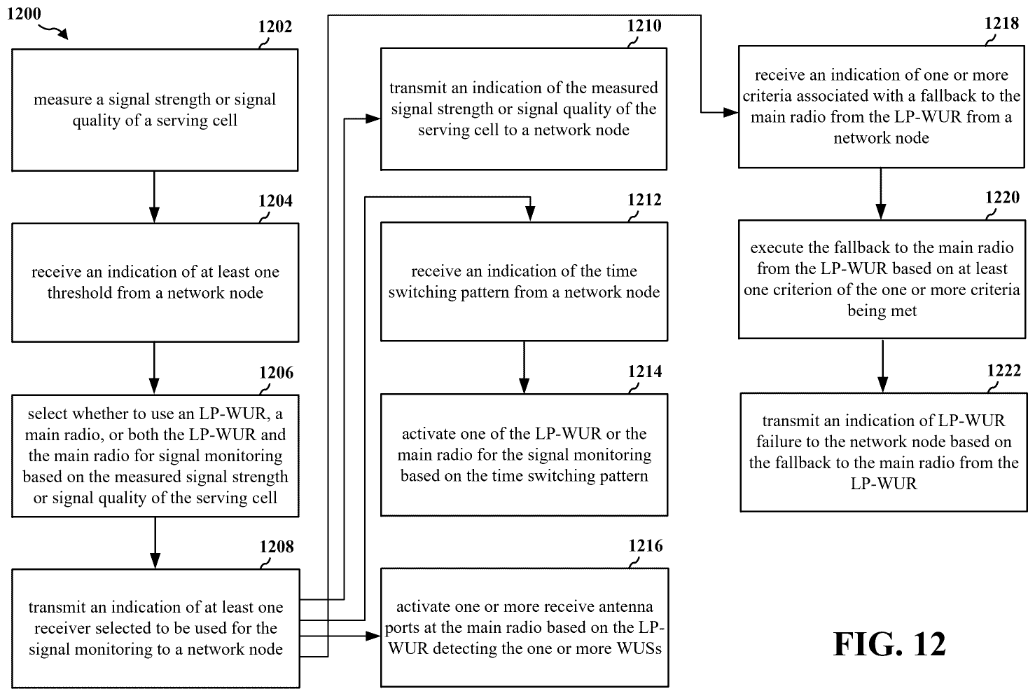

FIG. 12 is a flowchart 1200 of a method of wireless communication. The method may be performed by a UE (e.g., the UE 104/350/1002; the apparatus 1304). At 1202, the UE may measure a signal strength or signal quality of a serving cell. For example, 1202 may be performed by the component 198 in FIG. 13. Referring to FIG. 10, at 1006, the UE 1002 may measure a signal strength or signal quality of a serving cell.

At 1206, the UE may select whether to use an LP-WUR, a main radio, or both the LP-WUR and the main radio for signal monitoring based on the measured signal strength or signal quality of the serving cell. The signal monitoring may be associated with at least one of WUS monitoring, SSB monitoring, or RRM measurement. For example, 1206 may be performed by the component 198 in FIG. 13. Referring to FIG. 10, at 1010, the UE 1002 may select whether to use an LP-WUR, a main radio, or both the LP-WUR and the main radio for signal monitoring based on the measured signal strength or signal quality of the serving cell.

In one configuration, referring to FIG. 10, the signal strength or the signal quality of the serving cell may be measured at 1006 using the main radio.

In one configuration, at 1204, the UE may receive an indication of at least one threshold from a network node. Whether to use the LP-WUR, the main radio, or both the LP-WUR and the main radio for the signal monitoring may be selected based further on the at least one threshold. For example, 1204 may be performed by the component 198 in FIG. 13. Referring to FIG. 10, at 1008, the UE 1002 may receive an indication of at least one threshold from a network node 1004.

In one configuration, the at least one threshold may include a first threshold and a second threshold. Referring to FIG. 10, the LP-WUR alone may be selected at 1010 to be used for the signal monitoring if the measured signal strength or signal quality of the serving cell is greater than the first threshold. Both the LP-WUR and the main radio may be selected at 1010 to be used for the signal monitoring if the measured signal strength or signal quality of the serving cell is less than the first threshold but greater than the second threshold. The main radio alone may be selected at 1010 to be used for the signal monitoring if the measured signal strength or signal quality of the serving cell is less than the second threshold.

In one configuration, the first threshold may be associated with intra-frequency measurement for cell reselection. The second threshold may be associated with inter-frequency or inter-RAT measurement for cell reselection.

In one configuration, the measured signal strength or signal quality of the serving cell may be greater than the first threshold. Referring to FIG. 10, the LP-WUR alone may be selected at 1010 to be used for the signal monitoring. The signal monitoring may correspond to the WUS monitoring or the RRM measurement. The RRM measurement may be associated with the serving cell.

In one configuration, the measured signal strength or signal quality of the serving cell may be less than the first threshold but greater than the second threshold. Referring to FIG. 10, both the LP-WUR and the main radio may be selected at 1010 to be used for the signal monitoring. The signal monitoring may correspond to at least one of the WUS monitoring using the LP-WUR, the RRM measurement associated with the serving cell using the LP-WUR, or the RRM measurement associated with a non-serving cell using the main radio.

In one configuration, the measured signal strength or signal quality of the serving cell may be less than the second threshold. Referring to FIG. 10, the main radio alone may be selected at 1010 to be used for the signal monitoring. The signal monitoring may correspond to the SSB monitoring or the RRM measurement associated with the serving cell or a non-serving cell.

In one configuration, referring to FIG. 10, the signal strength or signal quality of the serving cell may be measured at 1006 based on at least one of an SSB, a CSI-RS, or an LP-SS. The LP-SS may be based on on-off keying.

In one configuration, referring to FIG. 10, the signal strength or signal quality of the serving cell may be measured at 1006 based on the SSB or the CSI-RS. The SSB or the CSI-RS may be QCLed with an LP-WUS associated with the WUS monitoring.

In one configuration, at 1208, the UE may transmit an indication of at least one receiver selected to be used for the signal monitoring to a network node. The at least one receiver may correspond to the LP-WUR alone, the main radio alone, or both the LP-WUR and the main radio. For example, 1208 may be performed by the component 198 in FIG. 13. Referring to FIG. 10, at 1012, the UE 1002 may transmit an indication of at least one receiver selected to be used for the signal monitoring to a network node 1004.

In one configuration, referring to FIG. 10, both the LP-WUR and the main radio may be selected at 1010 to be used for the signal monitoring. At 1210, the UE may transmit an indication of the measured signal strength or signal quality of the serving cell to a network node. A main radio wakeup pattern may be based on the measured signal strength or signal quality of the serving cell. For example, 1210 may be performed by the component 198 in FIG. 13. Referring to FIG. 10, at 1014, the UE 1002 may transmit an indication of the measured signal strength or signal quality of the serving cell to a network node 1004.

In one configuration, referring to FIG. 10, the UE 1002 may be in an RRC inactive state. The indication of the measured signal strength or signal quality of the serving cell may be transmitted at 1014 to the network node 1004 via an SDT.

In one configuration, referring to FIG. 10, both the LP-WUR and the main radio may be selected at 1010 to be used for the signal monitoring. The signal monitoring may correspond to at least the WUS monitoring using the LP-WUR and the SSB monitoring using the main radio. The WUS monitoring using the LP-WUR and the SSB monitoring using the main radio may be TDMed and/or SDMed.

In one configuration, the WUS monitoring using the LP-WUR and the SSB monitoring using the main radio may be TDMed based on a time switching pattern. At 1212, the UE may receive an indication of the time switching pattern from a network node. For example, 1212 may be performed by the component 198 in FIG. 13. Referring to FIG. 10, at 1016, the UE 1002 may receive an indication of the time switching pattern from a network node 1004.

At 1214, the UE may activate one of the LP-WUR or the main radio for the signal monitoring based on the time switching pattern. For example, 1214 may be performed by the component 198 in FIG. 13. Referring to FIG. 10, at 1018, the UE 1002 may activate one of the LP-WUR or the main radio for the signal monitoring based on the time switching pattern.

In one configuration, the time switching pattern may include a proportion of paging cycles associated with the WUS monitoring using the LP-WUR in a predefined number of paging cycles. The proportion of paging cycles may be based on the measured signal strength or signal quality of the serving cell.

In one configuration, the WUS monitoring using the LP-WUR and the SSB monitoring using the main radio may be SDMed. The LP-WUR and the main radio may be associated with different receive antenna ports. At 1216, the UE may activate one or more receive antenna ports at the main radio based on the LP-WUR detecting one or more WUSs. The one or more receive antenna ports may be associated with the LP-WUR prior to the LP-WUR detecting the one or more WUSs. For example, 1216 may be performed by the component 198 in FIG. 13. Referring to FIG. 10, at 1020, the UE 1002 may activate one or more receive antenna ports at the main radio based on the LP-WUR detecting one or more WUSs.

In one configuration, at 1218, the UE may receive an indication of one or more criteria associated with a fallback to the main radio from the LP-WUR from a network node. The one or more criteria may be associated with at least one of a timer that is started or restarted after an LP-SS or an LP-WUS is received, a predefined number of missed LP-SSs within a time interval, or a signal strength threshold associated with the LP-SSs. For example, 1216 may be performed by the component 198 in FIG. 13. Referring to FIG. 10, at 1022, the UE 1002 may receive an indication of one or more criteria associated with a fallback to the main radio from the LP-WUR from a network node 1004.

In one configuration, at 1220, the UE may execute the fallback to the main radio from the LP-WUR based on at least one criterion of the one or more criteria being met. For example, 1220 may be performed by the component 198 in FIG. 13. Referring to FIG. 10, at 1024, the UE 1002 may execute the fallback to the main radio from the LP-WUR based on at least one criterion of the one or more criteria being met.

At 1222, the UE may transmit an indication of LP-WUR failure to the network node based on the fallback to the main radio from the LP-WUR. For example, 1222 may be performed by the component 198 in FIG. 13. Referring to FIG. 10, at 1026, the UE 1002 may transmit an indication of LP-WUR failure to the network node 1004 based on the fallback to the main radio from the LP-WUR.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the component 198 is configured to measure a signal strength or signal quality of a serving cell. The component 198 is configured to select whether to use an LP-WUR, a main radio, or both the LP-WUR and the main radio for signal monitoring based on the measured signal strength or signal quality of the serving cell. The signal monitoring may be associated with at least one of WUS monitoring, SSB monitoring, or RRM measurement. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for measuring a signal strength or signal quality of a serving cell. The apparatus 1304, and in particular the cellular baseband processor 1324 and/or the application processor 1306, includes means for selecting whether to use an LP-WUR, a main radio, or both the LP-WUR and the main radio for signal monitoring based on the measured signal strength or signal quality of the serving cell. The signal monitoring may be associated with at least one of WUS monitoring, SSB monitoring, or RRM measurement.

In one configuration, the signal strength or the signal quality of the serving cell may be measured using the main radio. In one configuration, the apparatus 1304, and in particular the cellular baseband processor 1324 and/or the application processor 1306, includes means for receiving an indication of at least one threshold from a network node, where whether to use the LP-WUR, the main radio, or both the LP-WUR and the main radio for the signal monitoring is selected based further on the at least one threshold. In one configuration, the at least one threshold may include a first threshold and a second threshold. The LP-WUR alone may be selected to be used for the signal monitoring if the measured signal strength or signal quality of the serving cell is greater than the first threshold. Both the LP-WUR and the main radio may be selected to be used for the signal monitoring if the measured signal strength or signal quality of the serving cell is less than the first threshold but greater than the second threshold.

The main radio alone may be selected to be used for the signal monitoring if the measured signal strength or signal quality of the serving cell is less than the second threshold. In one configuration, the first threshold may be associated with intra-frequency measurement for cell reselection. The second threshold may be associated with inter-frequency or inter-RAT measurement for cell reselection. In one configuration, the measured signal strength or signal quality of the serving cell may be greater than the first threshold. The LP-WUR alone may be selected to be used for the signal monitoring. The signal monitoring may correspond to the WUS monitoring or the RRM measurement. The RRM measurement may be associated with the serving cell. In one configuration, the measured signal strength or signal quality of the serving cell may be less than the first threshold but greater than the second threshold. Both the LP-WUR and the main radio may be selected to be used for the signal monitoring. The signal monitoring may correspond to at least one of the WUS monitoring using the LP-WUR, the RRM measurement associated with the serving cell using the LP-WUR, or the RRM measurement associated with a non-serving cell using the main radio. In one configuration, the measured signal strength or signal quality of the serving cell may be less than the second threshold. The main radio alone may be selected to be used for the signal monitoring. The signal monitoring may correspond to the SSB monitoring or the RRM measurement associated with the serving cell or a non-serving cell. In one configuration, the signal strength or signal quality of the serving cell may be measured based on at least one of an SSB, a CSI-RS, or an LP-SS. The LP-SS may be based on on-off keying. In one configuration, the signal strength or signal quality of the serving cell may be measured based on the SSB or the CSI-RS. The SSB or the CSI-RS may be QCLed with an LP-WUS associated with the WUS monitoring. In one configuration, the apparatus 1304, and in particular the cellular baseband processor 1324 and/or the application processor 1306, includes means for transmitting an indication of at least one receiver selected to be used for the signal monitoring to a network node. The at least one receiver may correspond to the LP-WUR alone, the main radio alone, or both the LP-WUR and the main radio. In one configuration, both the LP-WUR and the main radio may be selected to be used for the signal monitoring. The apparatus 1304, and in particular the cellular baseband processor 1324 and/or the application processor 1306, includes means for transmitting an indication of the measured signal strength or signal quality of the serving cell to a network node. A main radio wakeup pattern may be based on the measured signal strength or signal quality of the serving cell. In one configuration, the UE may be in an RRC inactive state. The indication of the measured signal strength or signal quality of the serving cell may be transmitted to the network node via an SDT. In one configuration, both the LP-WUR and the main radio may be selected to be used for the signal monitoring. The signal monitoring may correspond to at least the WUS monitoring using the LP-WUR and the SSB monitoring using the main radio. The WUS monitoring using the LP-WUR and the SSB monitoring using the main radio may be TDMed and/or SDMed. In one configuration, the WUS monitoring using the LP-WUR and the SSB monitoring using the main radio may be TDMed based on a time switching pattern. The apparatus 1304, and in particular the cellular baseband processor 1324 and/or the application processor 1306, includes means for receiving an indication of the time switching pattern from a network node. The apparatus 1304, and in particular the cellular baseband processor 1324 and/or the application processor 1306, includes means for activating one of the LP-WUR or the main radio for the signal monitoring based on the time switching pattern. In one configuration, the time switching pattern may include a proportion of paging cycles associated with the WUS monitoring using the LP-WUR in a predefined number of paging cycles. The proportion of paging cycles may be based on the measured signal strength or signal quality of the serving cell. In one configuration, the WUS monitoring using the LP-WUR and the SSB monitoring using the main radio may be SDMed. The LP-WUR and the main radio may be associated with different receive antenna ports. The apparatus 1304, and in particular the cellular baseband processor 1324 and/or the application processor 1306, includes means for activating one or more receive antenna ports at the main radio based on the LP-WUR detecting one or more WUSs. The one or more receive antenna ports may be associated with the LP-WUR prior to the LP-WUR detecting the one or more WUSs. In one configuration, the apparatus 1304, and in particular the cellular baseband processor 1324 and/or the application processor 1306, includes means for receiving an indication of one or more criteria associated with a fallback to the main radio from the LP-WUR from a network node. The one or more criteria may be associated with at least one of a timer that is started or restarted after an LP-SS or an LP-WUS is received, a predefined number of missed LP-SSs within a time interval, or a signal strength threshold associated with the LP-SSs. In one configuration, the apparatus 1304, and in particular the cellular baseband processor 1324 and/or the application processor 1306, includes means for executing the fallback to the main radio from the LP-WUR based on at least one criterion of the one or more criteria being met. The apparatus 1304, and in particular the cellular baseband processor 1324 and/or the application processor 1306, includes means for transmitting an indication of LP-WUR failure to the network node based on the fallback to the main radio from the LP-WUR.

The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

Referring back to FIGS. 4-13, a UE may measure a signal strength or signal quality of a serving cell. The UE may select whether to use an LP-WUR, a main radio, or both the LP-WUR and the main radio for signal monitoring based on the measured signal strength or signal quality of the serving cell. The signal monitoring may be associated with at least one of WUS monitoring, SSB monitoring, or RRM measurement. Accordingly, by using the appropriate receiver for signal monitoring, the UE may not miss any WUS and may not fail to wake up the main radio when the UE is at the cell edge. Further, power savings associated with the use of the WUR may be preserved by not waking up the main radio unnecessarily frequently. The aspects may be used even if the WUR uses a single-bit ADC or comparator.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE, including measuring a signal strength or signal quality of a serving cell; and selecting whether to use an LP-WUR, a main radio, or both the LP-WUR and the main radio for signal monitoring based on the measured signal strength or signal quality of the serving cell, the signal monitoring being associated with at least one of WUS monitoring, SSB monitoring, or RRM measurement.
Aspect 2 is the method of aspect 1, where the signal strength or the signal quality of the serving cell is measured using the main radio.
Aspect 3 is the method of any of aspects 1 and 2, further including: receiving an indication of at least one threshold from a network node, where whether to use the LP-WUR, the main radio, or both the LP-WUR and the main radio for the signal monitoring is selected based further on the at least one threshold.
Aspect 4 is the method of aspect 3, where the at least one threshold includes a first threshold and a second threshold, the LP-WUR alone is selected to be used for the signal monitoring if the measured signal strength or signal quality of the serving cell is greater than the first threshold, both the LP-WUR and the main radio are selected to be used for the signal monitoring if the measured signal strength or signal quality of the serving cell is less than the first threshold but greater than the second threshold, and the main radio alone is selected to be used for the signal monitoring if the measured signal strength or signal quality of the serving cell is less than the second threshold.
Aspect 5 is the method of aspect 4, where the first threshold is associated with intra-frequency measurement for cell reselection, and the second threshold is associated with inter-frequency or inter-RAT measurement for cell reselection.
Aspect 6 is the method of aspect 5, where the measured signal strength or signal quality of the serving cell is greater than the first threshold, the LP-WUR alone is selected to be used for the signal monitoring, the signal monitoring corresponds to the WUS monitoring or the RRM measurement, and the RRM measurement is associated with the serving cell.
Aspect 7 is the method of aspect 5, where the measured signal strength or signal quality of the serving cell is less than the first threshold but greater than the second threshold, both the LP-WUR and the main radio are selected to be used for the signal monitoring, and the signal monitoring corresponds to at least one of the WUS monitoring using the LP-WUR, the RRM measurement associated with the serving cell using the LP-WUR, or the RRM measurement associated with a non-serving cell using the main radio.
Aspect 8 is the method of aspect 5, where the measured signal strength or signal quality of the serving cell is less than the second threshold, the main radio alone is selected to be used for the signal monitoring, and the signal monitoring corresponds to the SSB monitoring or the RRM measurement associated with the serving cell or a non-serving cell.
Aspect 9 is the method of any of aspects 1 to 8, where the signal strength or signal quality of the serving cell is measured based on at least one of an SSB, a CSI-RS, or an LP-SS, and the LP-SS is based on on-off keying.
Aspect 10 is the method of aspect 9, where the signal strength or signal quality of the serving cell is measured based on the SSB or the CSI-RS, and the SSB or the CSI-RS is QCLed with an LP-WUS associated with the WUS monitoring.
Aspect 11 is the method of any of aspects 1 to 10, further including: transmitting an indication of at least one receiver selected to be used for the signal monitoring to a network node, where the at least one receiver corresponds to the LP-WUR alone, the main radio alone, or both the LP-WUR and the main radio.
Aspect 12 is the method of any of aspects 1, 2, and 9 to 11, where both the LP-WUR and the main radio are selected to be used for the signal monitoring, and method further includes: transmitting an indication of the measured signal strength or signal quality of the serving cell to a network node, and where a main radio wakeup pattern is based on the measured signal strength or signal quality of the serving cell.
Aspect 13 is the method of aspect 12, where the UE is in an RRC inactive state, and the indication of the measured signal strength or signal quality of the serving cell is transmitted to the network node via an SDT.
Aspect 14 is the method of any of aspects 1, 2, and 9 to 11, where both the LP-WUR and the main radio are selected to be used for the signal monitoring, the signal monitoring corresponds to at least the WUS monitoring using the LP-WUR and the SSB monitoring using the main radio, and the WUS monitoring using the LP-WUR and the SSB monitoring using the main radio are TDMed and/or SDMed.
Aspect 15 is the method of aspect 14, where the WUS monitoring using the LP-WUR and the SSB monitoring using the main radio are TDMed based on a time switching pattern, and the method further includes: receiving an indication of the time switching pattern from a network node; and activating one of the LP-WUR or the main radio for the signal monitoring based on the time switching pattern.
Aspect 16 is the method of aspect 15, where the time switching pattern includes a proportion of paging cycles associated with the WUS monitoring using the LP-WUR in a predefined number of paging cycles, and the proportion of paging cycles is based on the measured signal strength or signal quality of the serving cell.
Aspect 17 is the method of aspect 14, where the WUS monitoring using the LP-WUR and the SSB monitoring using the main radio are SDMed, the LP-WUR and the main radio are associated with different receive antenna ports, and the method further includes: activating one or more receive antenna ports at the main radio based on the LP-WUR detecting one or more WUSs, the one or more receive antenna ports being associated with the LP-WUR prior to the LP-WUR detecting the one or more WUSs.
Aspect 18 is the method of any of aspects 1 to 6 and 9 to 11, further including: receiving an indication of one or more criteria associated with a fallback to the main radio from the LP-WUR from a network node, where the one or more criteria are associated with at least one of a timer that is started or restarted after an LP-SS or an LP-WUS is received, a predefined number of missed LP-SSs within a time interval, or a signal strength threshold associated with the LP-SSs.
Aspect 19 is the method of aspect 18, further including: executing the fallback to the main radio from the LP-WUR based on at least one criterion of the one or more criteria being met; and transmitting an indication of LP-WUR failure to the network node based on the fallback to the main radio from the LP-WUR.
Aspect 20 is an apparatus for wireless communication including at least one processor coupled to a memory and, based at least in part on information stored in the memory, the at least one processor is configured to implement a method as in any of aspects 1 to 19.
Aspect 21 may be combined with aspect 20 and further includes a transceiver coupled to the at least one processor.
Aspect 22 is an apparatus for wireless communication including means for implementing any of aspects 1 to 19.
Aspect 23 is a non-transitory computer-readable storage medium storing computer executable code, where the code when executed by a processor causes the processor to implement any of aspects 1 to 19.

Various aspects have been described herein. These and other aspects are within the scope of the following claims.

1. An apparatus for wireless communication at a user equipment (UE), comprising:
a memory; and
at least one processor coupled to the memory and, based at least in part on information stored in the memory, the at least one processor is configured to:
measure a signal strength or signal quality of a serving cell; and
select whether to use a low power-wakeup receiver (LP-WUR), a main radio, or both the LP-WUR and the main radio for signal monitoring based on the measured signal strength or signal quality of the serving cell, the signal monitoring being associated with at least one of wakeup signal (WUS) monitoring, synchronization signal block (SSB) monitoring, or radio resource management (RRM) measurement.

2. The apparatus of claim 1, wherein the signal strength or the signal quality of the serving cell is measured using the main radio.

3. The apparatus of claim 1, the at least one processor being further configured to:
receive an indication of at least one threshold from a network node, wherein whether to use the LP-WUR, the main radio, or both the LP-WUR and the main radio for the signal monitoring is selected based further on the at least one threshold.

4. The apparatus of claim 3, wherein the at least one threshold includes a first threshold and a second threshold, the LP-WUR alone is selected to be used for the signal monitoring if the measured signal strength or signal quality of the serving cell is greater than the first threshold, both the LP-WUR and the main radio are selected to be used for the signal monitoring if the measured signal strength or signal quality of the serving cell is less than the first threshold but greater than the second threshold, and the main radio alone is selected to be used for the signal monitoring if the measured signal strength or signal quality of the serving cell is less than the second threshold.

5. The apparatus of claim 4, wherein the first threshold is associated with intra-frequency measurement for cell reselection, and the second threshold is associated with inter-frequency or inter-radio access technology (RAT) measurement for cell reselection.

6. The apparatus of claim 5, wherein the measured signal strength or signal quality of the serving cell is greater than the first threshold, the LP-WUR alone is selected to be used for the signal monitoring, the signal monitoring corresponds to the WUS monitoring or the RRM measurement, and the RRM measurement is associated with the serving cell.

7. The apparatus of claim 5, wherein the measured signal strength or signal quality of the serving cell is less than the first threshold but greater than the second threshold, both the LP-WUR and the main radio are selected to be used for the signal monitoring, and the signal monitoring corresponds to at least one of the WUS monitoring using the LP-WUR, the RRM measurement associated with the serving cell using the LP-WUR, or the RRM measurement associated with a non-serving cell using the main radio.

8. The apparatus of claim 5, wherein the measured signal strength or signal quality of the serving cell is less than the second threshold, the main radio alone is selected to be used for the signal monitoring, and the signal monitoring corresponds to the SSB monitoring or the RRM measurement associated with the serving cell or a non-serving cell.

9. The apparatus of claim 1, wherein the signal strength or signal quality of the serving cell is measured based on at least one of an SSB, a channel state information—reference signal (CSI-RS), or a low power—synchronization signal (LP-SS), and the LP-SS is based on on-off keying.

10. The apparatus of claim 9, wherein the signal strength or signal quality of the serving cell is measured based on the SSB or the CSI-RS, and the SSB or the CSI-RS is quasi co-located (QCLed) with a low power—WUS (LP-WUS) associated with the WUS monitoring.

11. The apparatus of claim 1, the at least one processor being further configured to:
transmit an indication of at least one receiver selected to be used for the signal monitoring to a network node, wherein the at least one receiver corresponds to the LP-WUR alone, the main radio alone, or both the LP-WUR and the main radio.

12. The apparatus of claim 1, wherein both the LP-WUR and the main radio are selected to be used for the signal monitoring, and the at least one processor is further configured to:
transmit an indication of the measured signal strength or signal quality of the serving cell to a network node, and wherein a main radio wakeup pattern is based on the measured signal strength or signal quality of the serving cell.

13. The apparatus of claim 12, wherein the UE is in a radio resource control (RRC) inactive state, and the indication of the measured signal strength or signal quality of the serving cell is transmitted to the network node via a small data transmission (SDT).

14. The apparatus of claim 1, wherein both the LP-WUR and the main radio are selected to be used for the signal monitoring, the signal monitoring corresponds to at least the WUS monitoring using the LP-WUR and the SSB monitoring using the main radio, and the WUS monitoring using the LP-WUR and the SSB monitoring using the main radio are time division multiplexed (TDMed) and/or spatial division multiplexed (SDMed).

15. The apparatus of claim 14, wherein the WUS monitoring using the LP-WUR and the SSB monitoring using the main radio are TDMed based on a time switching pattern, and the at least one processor is further configured to:
receive an indication of the time switching pattern from a network node; and
activate one of the LP-WUR or the main radio for the signal monitoring based on the time switching pattern.

16. The apparatus of claim 15, wherein the time switching pattern includes a proportion of paging cycles associated with the WUS monitoring using the LP-WUR in a predefined number of paging cycles, and the proportion of paging cycles is based on the measured signal strength or signal quality of the serving cell.

17. The apparatus of claim 14, wherein the WUS monitoring using the LP-WUR and the SSB monitoring using the main radio are SDMed, the LP-WUR and the main radio are associated with different receive antenna ports, and the at least one processor is further configured to:
activate one or more receive antenna ports at the main radio based on the LP-WUR detecting one or more WUSs, the one or more receive antenna ports being associated with the LP-WUR prior to the LP-WUR detecting the one or more WUSs.

18. The apparatus of claim 1, the at least one processor being further configured to:
receive an indication of one or more criteria associated with a fallback to the main radio from the LP-WUR from a network node, wherein the one or more criteria are associated with at least one of a timer that is started or restarted after a low power—synchronization signal (LP-SS) or a low power—WUS (LP-WUS) is received, a predefined number of missed LP-SSs within a time interval, or a signal strength threshold associated with the LP-SSs.

19-20. (canceled)

21. A method of wireless communication at a user equipment (UE), comprising:
measuring a signal strength or signal quality of a serving cell; and
selecting whether to use a low power—wakeup receiver (LP-WUR), a main radio, or both the LP-WUR and the main radio for signal monitoring based on the measured signal strength or signal quality of the serving cell, the signal monitoring being associated with at least one of wakeup signal (WUS) monitoring, synchronization signal block (SSB) monitoring, or radio resource management (RRM) measurement.

22-28. (canceled)

29. An apparatus for wireless communication at a user equipment (UE), comprising:
means for measuring a signal strength or signal quality of a serving cell; and
means for selecting whether to use a low power—wakeup receiver (LP-WUR), a main radio, or both the LP-WUR and the main radio for signal monitoring based on the measured signal strength or signal quality of the serving cell, the signal monitoring being associated with at least one of wakeup signal (WUS) monitoring, synchronization signal block (SSB) monitoring, or radio resource management (RRM) measurement.

30. (canceled)
